(19) United States
(12) Patent Application Publication
(10) Pub. No.: US 2010/0181238 A1
(43) Pub. Date: Jul. 22, 2010

(54) FILTRATION DEVICE FOR FLUID CIRCULATING IN AN ENGINE OR A PIECE OF HYDRAULIC EQUIPMENT, COMPRISED OF A MEANS FOR HEATING THE FLUID ADJOINING THE FILTRATION MEANS

(75) Inventor: Christophe Henry, Langolen (FR)

Correspondence Address: HAMRE, SCHUMANN, MUELLER & LARSON, P.C., P.O. BOX 2902, MINNEAPOLIS, MN, 55402-0902, US

(73) Assignee: CUMMINS FILTRATION IP INC., Minneapolis, MN (US)

(21) Appl. No.: 12/687,705

(22) Filed: Jan. 14, 2010

(30) Foreign Application Priority Data
Jan. 19, 2009 (FR) 09/00216

(51) Int. Cl. B01D 35/02; B01D 29/11; B01D 35/18

(52) U.S. Cl. 210/167.32

(57) ABSTRACT

The object of the invention is a filtration device for fluid circulating in an engine or a piece of hydraulic equipment, of the kind comprised of a filtration means through which said fluid is intended to circulate and a means of electrically heating said fluid, characterized in that said device comprises a passage window for said fluid in which are placed said heating means and wherein said filtration means adjoins said heating means.

The invention relates to the field of designing and manufacturing filtration devices used to filter fluids circulating in engines or in hydraulic equipment.

As a general rule, such filtration devices consist of an element exhibiting passage windows for the fluid being filtered, and a filtration means which can consist of a synthetic fiber fabric extending into the window or windows of said element. Filtration devices of this nature most often exhibit a cylindrical shape, although they may also exhibit any other shape.

A particular application of the invention relates to decontamination devices for exhaust gases associated with vehicle exhaust lines; the purpose of such devices being to reduce the amount of diverse particles and gaseous emissions being discharged into the environment, namely: CO, unburned hydrocarbons (HC), sulfur oxides (SOx), and nitrous oxides (NOx).

In this application, it has hence become common practice to use SCR (Selective Catalytic Reduction) catalysis to treat the NOx emitted by diesel engines. The principle of such a technique is to reduce the NOx chemically by adding a reducing agent (e.g., ammonia) upstream of a specific SCR catalyst and thus to enable this type of engine to comply with increasingly tighter restrictions on emission levels being imposed by the standards now in effect and also by those to come.

Typically, the ammonia introduced in the exhaust line is most often in the form of a precursor compound such as urea, which generates ammonia as it breaks down at the temperatures prevailing in the exhaust gases shortly after it is introduced.

The urea mixes with the exhaust gas and then reacts with the NOx therein on the SCR catalyst.

Upon leaving the SCR catalyst, the urea is recycled in order that it may be reintroduced in the catalyst after it has been filtered (which obviously requires the implementation of a filtration device).

In such a system, the urea is subjected to climatic conditions, particularly as regards temperature variations.

Also, when the temperature drops appreciably, the properties of the urea change: increase in viscosity, increase in crystallization, etc.

Such property changes result in a variable capacity of the fluid (in this case the urea) to be filtered and as a consequence, an inconsistent quality of filtration.

This phenomenon is likewise observed in other applications with other fluids, for example, filtering of fuel, brake fluid, or also power steering fluid.

At the present time, one solution consists of conducting the concerned fluid into a heating device placed upstream from and remote from the filtration device. The goal thereof is to reduce the viscosity and the crystallization of the fluid being filtered by bringing it to a suitable temperature level.

With prior art solutions, however, it has been observed that a temperature loss may take place between the heating device and the filtration device with the result that the fluid being filtered does not reach the suitable temperature in the filtration device.

Furthermore, the heating device constitutes a component that must be installed separately from the filtration device and one that itself constitutes extra bulk that needs to be dealt with.

In particular, the objective of the invention is to overcome these prior art disadvantages.

More precisely, the objective of the invention is to propose a technique that assures that the fluid being filtered is at an optimum temperature at the time of its filtration in all or nearly all circumstances.

The objective of the invention is, likewise, the provision of such a technique that enables the reduction of the overall bulk of a filtration line for a liquid being filtered.

The objective of the invention is also the provision of such a technique that enables the reduction of the time it takes to install a filtration line for a liquid being filtered.

These objectives, as well as others that will emerge in following, are achieved thanks to the invention, of which the object is a filtration device for fluid circulating in an engine or a piece of hydraulic equipment, of the kind comprising filtration means through which said fluid is intended to circulate and the means of electrically heating said fluid, characterized in that said device comprises a passage window for said fluid in which said heating means are placed and wherein said filtration means adjoin said heating means.

Hence the invention proposes an approach in which the means for heating the fluid being filtered are placed immediately in the vicinity of the filtration mean.

A direct consequence of an assembly according to the invention is that the temperature to which the fluid being filtered is brought by the heating means is likewise the temperature of the fluid when the latter passes through the filtration means.

In fact, the immediate proximity of the heating means and the filtration means reduces the transit time of the fluid being filtered between the heating means and the filtration means to an infinitesimal amount, during which the fluid being filtered does not have time to cool, given the temperature conditions surrounding the filtration device.

The filtration of the fluid thus takes place under ideal conditions in terms of the viscosity and the crystallization of the fluid being filtered.

Furthermore, the invention makes it possible to:
reduce the overall bulk of the filtration line, as the heating means can be directly incorporated on the filtration device, as will emerge more clearly in following;
reduce the time it takes to install the filtration line in the vehicle, as the installation of the heating means and that of the filtration means can be accomplished simultaneously.

According to a first embodiment of the invention, said heating means and said filtration means are installed in the same passage window for said fluid.

Hence it can be clearly discerned that the distance separating the heating means from the filtration means is reduced as much as possible; the fluid being filtered thus passing through the filtration means under ideal temperature conditions.

In this case, said filtration means are comprised of a fabric and said heating means are comprised of at least one electrically conductive filament applied on said fabric, with preference given to said heating means comprised of a mesh of electrically conductive filaments integrated in said fabric.

A particularly simple, efficient, and compact device is thus obtained: the filtration means serve a dual function: an intrinsic filtering function and a support function for the heating means.

According to this embodiment, the heating means are thus obviously incorporated on the filtration device. The heating means do not therefore constitute an additional device of the filtration device that requires a specific installation operation and adds additional bulk to that of the filtration device.

According to a second embodiment of the invention, said heating means are placed in a first passage window for said fluid and said filtration means are placed in a second passage window for said fluid distinct from said first window.

According to this embodiment, the heating means and the filtration means may be placed on supports that are independent from each other. In this case it is possible to service the filtration means and the heating means separately, thus potentially reducing maintenance costs (replacement of just the heating means or just the filtration means).

According to a preferred solution of this embodiment, said heating means take the form of a hollow element and said filtration means are placed on an element designed to fit into said hollow body.

It is understood that in this manner a particularly integrated device is obtained while retaining the possibility of configuring the device in a very compact form.

However, mention is made that for certain particular applications it is the filtration means that may take the form of a hollow body, in which case it is the heating means that would then be placed on an element that fits into the hollow body.

In accordance with an advantageous embodiment, said heating means comprise a film permeable to said fluid and on which at least one electrically conductive filament is applied, with preference given to the heating means comprising a mesh of electrically conductive filaments integrated in said film.

Said film is advantageously made of a textile material.

According to one or the other of the embodiments previously described, said heating means are advantageously placed in at least one passage window formed in a support exhibiting electric attachment means designed for supplying power to said heating means.

A support is thus obtained that makes the filtration device and the associated heating means easier to install. In fact the device is installed during a first time period, independently of the presence of the electric filaments; the power supply for the heating means is then capable of being positioned and connected to the support by a simple maneuver consisting of a mechanical coupling.

Said filtration means advantageously consist of a fabric of synthetic fibers.

Hence use may still be made of materials that are standardly employed for executing the filtration function for a fluid being filtered.

Other characteristics and advantages of the invention will emerge more clearly in reading the following description of two embodiments of the invention provided by way of simple illustrative and non limiting examples and referring to the appended drawings, wherein:

FIG. 1 is a perspective view of a filtration device of a first embodiment of the invention;

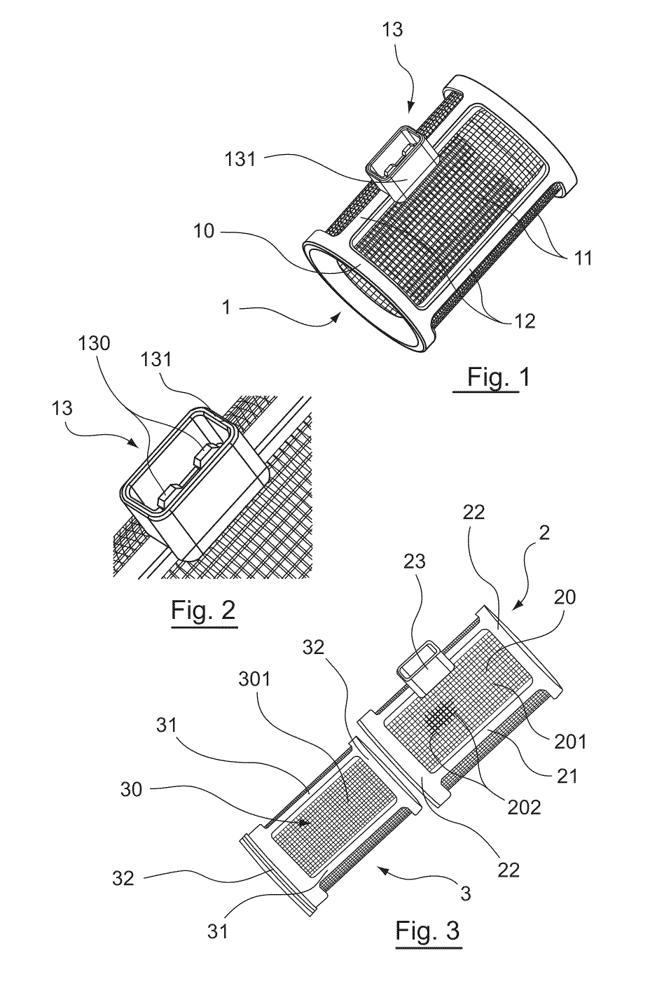

FIG. 2 is a detailed illustration of the electrical attachment means of a filtration device of the invention;

FIG. 3 is a perspective view of a filtration device of a second embodiment of the invention, showing the filtration means and the heating means separately;

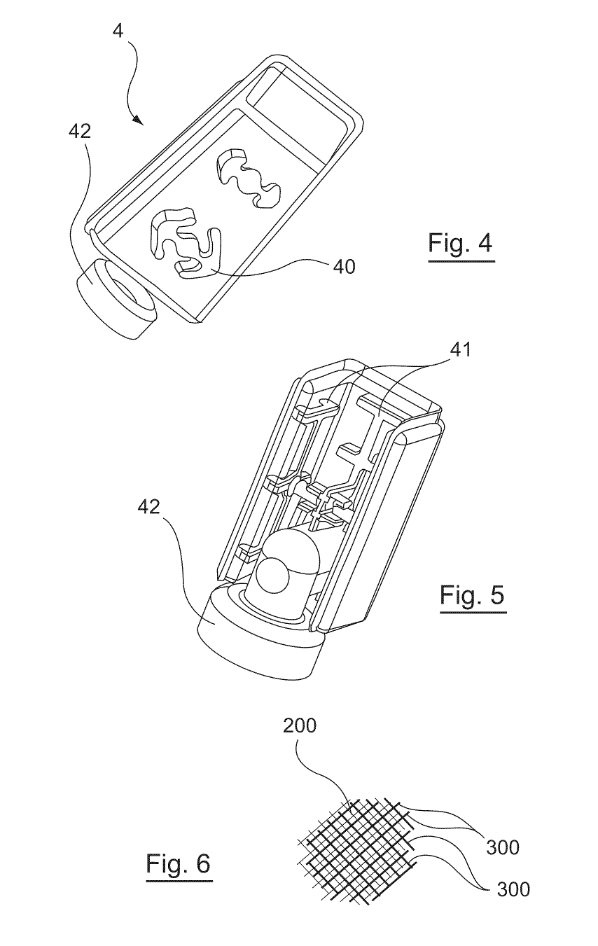

FIGS. 4 and 5 are illustrations of a filtration device of a variant of embodiment of the invention;

FIG. 6 is a diagrammatic illustration of a filtration fabric associated with the heating means designed to equip the filtration means of the invention;

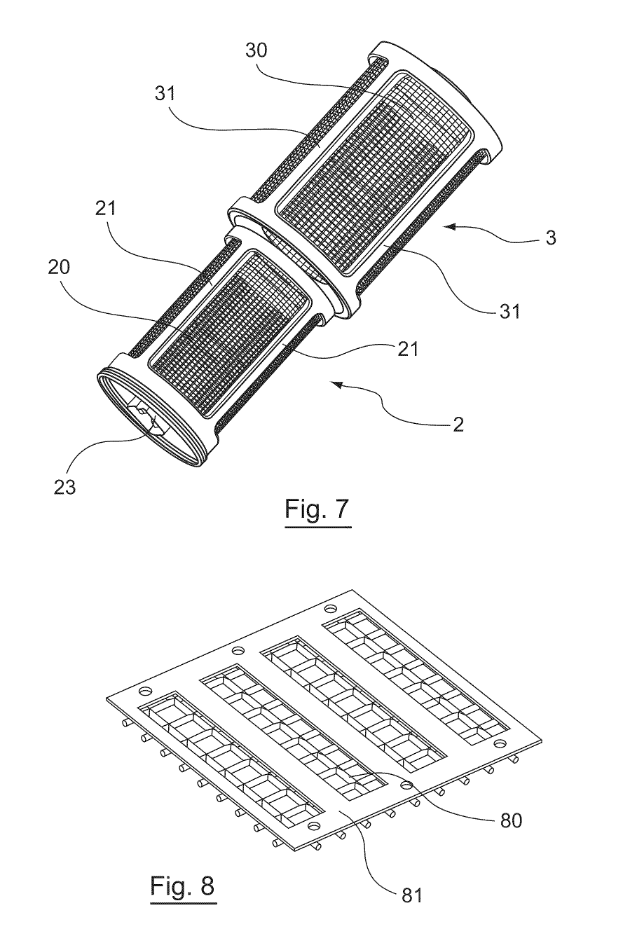

FIG. 7 is a perspective view of a filtration device of a third embodiment of the invention, showing the filtration means and the heating means separately;

FIGS. 8 through 10 each illustrate a variant of embodiment of a heating/filtering device designed to equip a device of the invention.

As indicated above, the principle of the invention resides in the act of designing a filtration device in which the means for heating the fluid being filtered are placed on the device in such a way that they adjoin the means for filtering the fluid.

FIG. 1 shows a first embodiment of the invention.

As shown in this figure, the filtration device comprises a body 1 exhibiting an essentially cylindrical shape in this embodiment.

The body 1 exhibits two ring-shaped ends 10 linked by a series of struts 12 placed parallel relative to each other and delimiting windows 11 forming a passage through which the fluid being filtered is intended to circulate.

According to this embodiment of the invention, the means for heating and the means for filtering the fluid extend into each window 11 of the device. In other words, the heating means adjoins the filtration means, thus making provision for the installation of the heating means in the same windows as those in which the filtration means extend.

In this case, the filtration means is comprised of a fabric of synthetic fibers 200 on which electrically conductive filaments 300 (constituting Joule effect heating means) are positioned; the filaments 300 being placed parallel, relative to each other, or placed in a mesh in such a way as to divide the surface of the filter fabric into squares, as schematically illustrated in FIG. 6.

It can be seen that in this manner the filtration fabric 200 directly supports the heating means constituted by the electrically conductive filaments 300.

The heating element can also be a hybrid fabric associating synthetic filaments and heat conducting filaments which can be metallic or metal-coated; such a fabric then assures a dual function, namely a heating function and a filtering function.

Moreover, the body 1 of the filtration device exhibits electric attachment means 13 designed to supply power to the electrically conductive filaments.

As illustrated in FIG. 2, these electric attachment means comprise:
a hollow element 131 delimiting a housing designed to receive an external electric connection pin (not shown) on the device;
two prongs 130 designed to form an electrical connection with the pin, said prongs 130 being placed in the housing delimited by the hollow element 131.

Each electrically conductive filament is connected by one of its ends to one of the prongs 130, whereas the other end of each filament is connected to the other prong 130, consequently constituting heating means by a series of parallel electric circuits in each case constituted by one prong 130, a conductive filament, and the second prong 130.

It is noted that the heating means that have just been described are constituted by one or a plurality of electrically conductive filaments emitting heat by the Joule effect. In other conceivable embodiments, however, the heating means may also be constituted by filaments made of certain alloys or ceramic filaments that combine heating and control functions. These means are known to the skilled professional and can be PTC means (Positive Temperature Coefficient) in which the resistance strongly increases in direct proportion to the temperature, thus controlling the heating. Such means are typically employed in standard diesel heaters.

FIG. 3 shows a second embodiment of the invention.

According to this embodiment, the filtration devices comprise:
an element dedicated to heating 2;
an element dedicated to filtering 3.

The element 2 dedicated to heating the fluid being filtered exhibits an essentially cylindrical shape, and at each of its ends exhibits a ring-shaped section 22, wherein the two ring-shaped sections are connected by a series of struts 21 delimiting passage windows 20 for the fluid being filtered between them.

A film 201 (made of a textile material) permeable to the fluid being filtered extends into each passage window 20 of the element 2 dedicated to heating the liquid being filtered; said film carrying electrically conductive filaments 202 placed parallel, relative to each other, or placed in such a way as to form a mesh dividing the film into squares.

The element 2 further comprises electric attachment means for supplying power to the electrically conductive filaments (constituting the Joule effect heating elements), such as the ones described previously in the scope of the first embodiment.

The element 2 thus forms a support in which passage windows for the fluid being filtered are formed; the heating means being placed in the windows of the element 2.

The element 3 designed to filter the fluid likewise exhibits an essentially cylindrical shape, and at each of its ends has a ring-shaped section 32, the two ring-shaped sections 32 being connected by a series of struts 31 delimiting between them passage windows 30 through which the fluid is filtered and intended to circulate.

The filtration means comprise a fabric 301 of synthetic fibers placed on the element 3 in such a way as to extend into each of the windows 30.

The element 2 forms a hollow body. Furthermore, the dimensions of the element 2 and the element 3 are configured in such a way that the element 3 fits into the element 2, as shown in FIG. 4.

Furthermore, the diameters of the element 2 and of the element 3 are configured in such a way that once the element 3 is inserted in the element 2, the windows 20 of the element 2 adjoin the windows 30 of the element 3.

In the two embodiments that have just been described, the fluid being filtered circulates from the outside of the filtration device to the internal hollowing of the filtration device. However, provision of a reverse circulation of the fluid being filtered by a simple adjustment to the filtration device is also conceivable (it is then necessary to change the position of the heating means in such a way that the fluid is heated before passing through the filtration means).

Depending on the applications (circulation of the “fluid” in the opposite direction or special mode of operation), it may be necessary to position the heating element in the interior of the filtering element.

FIG. 7 shows a variant of embodiment of the invention corresponding to this configuration. As can be discerned in this figure, the element 3 designed for filtering forms a hollow body and the dimensions of the element 2 and the element 3 are configured so that the element 2 can fit inside the element 3. Moreover, it is understood that according to this variant, the element 2 forms a support in which are formed passage windows for the fluid being filtered, wherein the heating means is placed in the windows of the element 2 and the element 3 has on each of its ends a ring-shaped section 32; the two ring-shaped sections 32 being linked by a series of struts 31 delimiting between them passage windows 30 through which the fluid is filtered and intended to circulate.

Furthermore, the diameters of the element 2 and of the element 3 are configured in such a way that once the element 2 is inserted in the element 3, the windows 20 of the element 2 adjoin the windows 30 of the element 3.

In the embodiments that have just been described, the filtration device has the form of an essentially cylindrical element.

According to a variant of embodiment illustrated in FIGS. 4 and 5, it can be observed that the filtration device can take any other shape, such as that of a case 4 exhibiting windows 40 communicating with collection conduits 41 that in turn open into a discharge element 42.

FIGS. 8 through 10 in each case illustrate a variant of embodiment in which the filtration means and the heating means are grouped in a single device.

As shown in FIG. 8, the device is a synthetic fabric 80 (forming a filtration element) on which is attached a conductive strip (of copper, etc.).

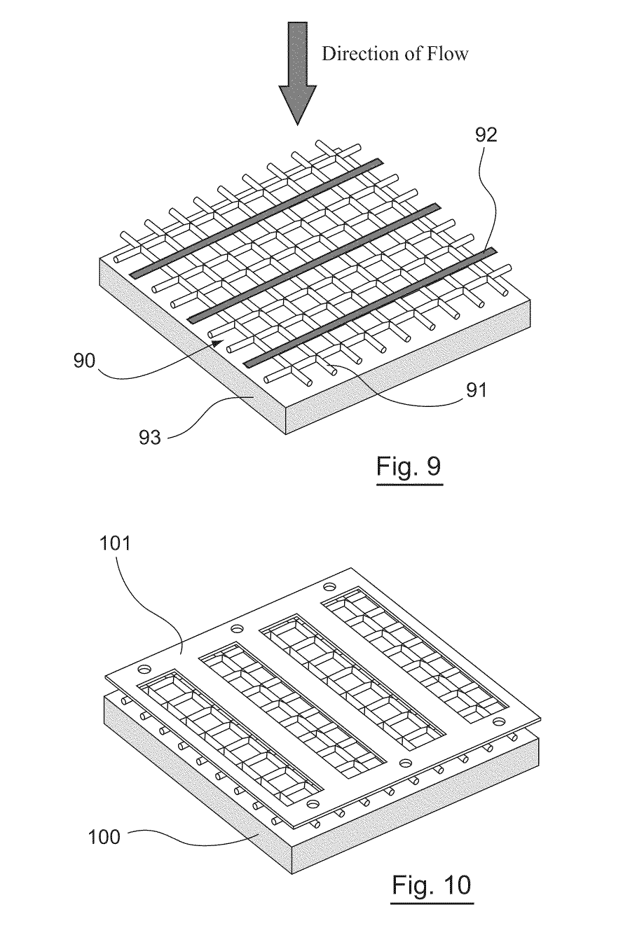

As illustrated in FIG. 9, the device is multilayer hybrid filtering film/medium 90 integrating woven synthetic filaments 91 on an upstream level on which metal or metal-coated elastomer heat conductive filaments 92 have been attached. On the next layer or layers, the device comprises a non-woven medium 93 and/or a cellulose layer.

As illustrated in FIG. 10, the device comprises a non-fabric and/or cellulose-based synthetic filtering film/medium 100 on which is attached a conductive strip 101 (of copper, etc.).

1. Filtration device for fluid circulating in an engine or a piece of hydraulic equipment, of the kind comprised of a filtration means through which said fluid is intended to circulate and means for electrically heating said fluid,
characterized in that it comprises a passage window for said fluid in which said heating means are placed and wherein said filtration means adjoins said heating means.

2. Filtration device as in claim 1, characterized in that said heating means and said filtration means are placed in the same passage window for said fluid.

3. Filtration device as in claim 2, characterized in that said filtration means are comprised of a fabric and said heating means are comprised of at least one electrically conductive filament on said fabric.

4. Filtration device as in claim 3, characterized in that said heating means are comprised of a mesh of electrically conductive filaments integrated in said fabric.

5. Filtration device as in claim 1, characterized in that said heating means are placed in a first passage window for said fluid and said filtration means are placed in a second passage window for said fluid distinct from said first window.

6. Filtration device as in claim 5, characterized in that said heating means have the form of a hollow element and said filtration means are placed on an element designed to fit into said hollow body.

7. Filtration device as in claim 5, characterized in that said heating means are comprised of a film permeable to said fluid and on which at least electrically conductive filament is applied.

8. Filtration device as in claim 7, characterized in that said heating means are comprised of a mesh of electrically conductive filaments integrated in said fabric.

9. Filtration device as in claim 7, characterized in that said film is made of a textile material.

10. Filtration device as in claim 1, characterized in that said heating means are placed in at least one passage window formed in a support exhibiting electrical attachment means for supplying power to said heating means.
